(19) United States
(12) Patent Application Publication
(10) Pub. No.: US 2005/0211131 A1
(43) Pub. Date: Sep. 29, 2005

(54) Ink

(76) Inventor: Gavin Wright, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 10/522,368

(22) PCT Filed: May 16, 2003
(86) PCT No.: PCT/GB03/02117

§ 371 Date: Jan. 25, 2005

(30) Foreign Application Priority Data
Jul. 27, 2002 (GB) 02174464
Sep. 16, 2002 (US) 60410810

(51) Int. Cl. C09D 11/02; B41J 2/01

(52) U.S. Cl. 106/31.5; 106/31.78; 347/100; 428/195.1

(57) ABSTRACT

An ink comprising:
(c) a metal chelate compound of Formula (1) or salt thereof, wherein M is nickel; 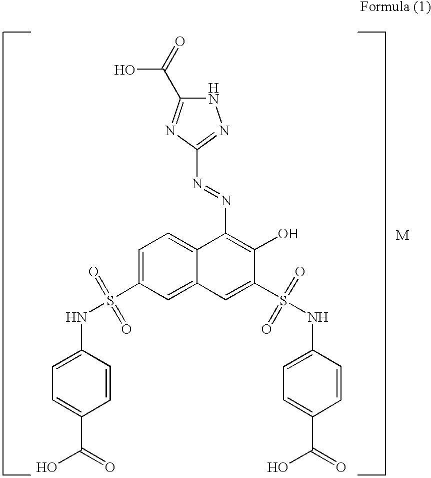 and (b) a liquid medium. The inks are useful for ink jet printers.

This invention relates to inks and to their use in ink jet printing (“IJP”). IJP is a non-impact printing technique in which droplets of ink are ejected through a fine nozzle onto a substrate without bringing the nozzle into contact with the substrate.

There are many demanding performance requirements for inks used in IJP. For example they desirably provide sharp, non-feathered images having good water-fastness, light-fastness and optical density. The inks are often required to dry quickly when applied to a substrate to prevent smudging, but they should not form a crust over the tip of an ink jet nozzle because this will stop the printer from working. The inks should also be stable to storage over time without decomposing or forming a precipitate which could block the fine nozzle.

WO 01/48090 relates to metal chelate azo compounds which comprise a naphthol component and certain heterocyclic groups. WO 01/48090 does not disclose such compounds further substituted by a triazole ring for use in ink formulations.

According to a first aspect of the present invention there is provided an ink comprising:

(a) A metal chelate compound of Formula (1) or salt thereof, wherein M is nickel; 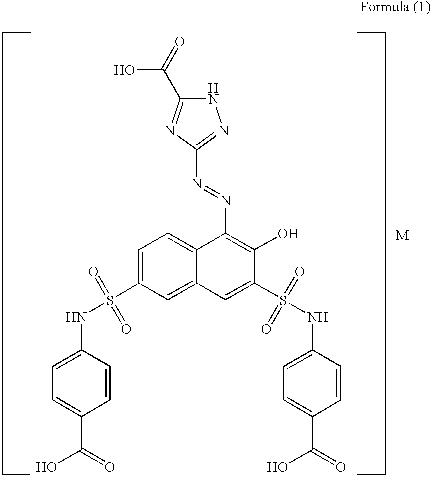
and (b) a liquid medium.

It is especially preferred that the inks comprising the compound of Formula (1) are magenta in colour.

The inks comprising the compound of Formula (1) provide prints which exhibit a high light-fastness, good fastness to oxidising gases such as ozone and good optical density, particularly when used for ink jet printing. The inks according to the present invention are also highly soluble which improves operability and reduces crusting and nozzle blockage when inks containing the compounds are used in an ink jet printer.

It is especially preferred that the compound of Formula (1) is in the form of a sodium, lithium, potassium, ammonium or substituted ammonium salt, because we have found that these salts provide prints which exhibit a high light-fastness when incorporated into an ink jet printing ink.

The metal chelate compound of Formula (1) or a salt thereof according to the present invention and the inks comprising the compound of Formula (1) also include tautomers thereof, especially tautomers of the triazole ring.

The compound of Formula (1) may be converted into a salt using known techniques. For example, an alkali metal salt of a compound may be converted into a salt with ammonia or an amine by dissolving an alkali metal salt of the dye in water and passing the solution through a column of a suitably modified ion exchange resin.

The inks according to the present invention may be, and preferably are, purified to remove undesirable impurities before they are incorporated into inks for ink jet printing. Conventional techniques may be employed for purification, for example ultrafiltration, reverse osmosis and/or dialysis.

The liquid medium preferably comprises:

(i) water;

(ii) a mixture of water and an organic solvent; or

(iii) an organic solvent free from water.

The number of parts by weight of component (a) of the ink is preferably from 0.01 to 30, more preferably 0.1 to 20, especially from 0.5 to 15, and more especially from 1 to 5 parts. The number of parts by weight of component (b) is preferably from 99.99 to 70, more preferably from 99.9 to 80, especially from 99.5 to 85, and more especially from 99 to 95 parts. The number of parts of (a)+(b) is 100 and all parts mentioned herein are by weight.

Preferably component (a) is completely dissolved in component (b). Preferably component (a) has a solubility in component (b) at 20° C. of at least 10%. This allows the preparation of concentrates which may be used to prepare more dilute inks and reduces the chance of the compound(s) of component (a) of the ink precipitating if evaporation of the liquid medium occurs during storage.

When the liquid medium comprises a mixture of water and an organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably the liquid medium comprises water and 2 or more, especially from 2 to 8, water-miscible organic solvents.

Especially preferred water-soluble organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono- C₁₋₄-alkyl and C₁₋₄-alkyl ethers of diols, more preferably mono- C₁₋₄-alkyl ethers of diols having 2 to 12 carbon atoms, especially 2-methoxy-2-ethoxy-2-ethoxyethanol.

When the liquid medium comprises an organic solvent free from water, (i.e. less than 1% water by weight) the solvent preferably has a boiling point of from 300 to 200° C., more preferably of from 40° to 150° C., especially from 50 to 125° C. The organic solvent may be water-immiscible, water-miscible or a mixture of such solvents. Preferred water-miscible organic solvents are any of the hereinbefore described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the metal chelate compound in the liquid medium. Examples of polar solvents include C₁₋₄-alcohols. In view of the foregoing preferences it is especially preferred that where the liquid medium is an organic solvent free from water it comprises a ketone (especially methyl ethyl ketone) and/or an alcohol (especially a C₁₋₄-alkanol, such as ethanol or propanol).

The organic solvent free from water may be a single organic solvent or a mixture of two or more organic solvents. It is preferred that when the medium is an organic solvent free from water it is a mixture of 2 to 5 different organic solvents. This allows a medium to be selected which gives good control over the drying characteristics and storage stability of the ink.

Ink media comprising an organic solvent free from water are particularly useful where fast drying times are required and particularly when printing onto hydrophobic and non-absorbent substrates, for example plastics, metal and glass.

An especially preferred ink comprises:
(i) 1 to 10 parts in total of the compound of Formula (1) or salt thereof;
(ii) 2 to 60, more preferably 5 to 40 parts of water-soluble organic solvent; and
(iii) 30 to 97, more preferably 40 to 85 parts water;
   wherein all parts are by weight and the sum of the parts (i)+(ii)+(iii)=100.

When the liquid medium in the ink comprises a mixture of water and an organic solvent; or an organic solvent free from water, component (i) of the ink may comprise a compound of the Formula (1) or salt thereof, as hereinbefore defined.

Preferred low melting solid media have a melting point in the range from 60° C. to 125° C. Suitable low melting point solids include long chain fatty acids or alcohols, preferably those with C₁₈₋₂₄ chains, and sulphonamides. A compound of Formula (1) may be dissolved in the low melting point solid or may be finely dispersed in it.

The inks according to the present invention may also contain additional components conventionally used in ink jet printing inks, for example viscosity and surface tension modifiers, corrosion inhibitors, biocides, kogation reducing additives, anti-cockle agents to reduce paper curling and surfactants which may be ionic or non-ionic.

The pH of the ink is preferably from 4 to 11, more preferably from 7 to 10.

The viscosity of the ink at 25° C. is preferably less than 50 cP, more preferably less than 20 cP and especially less than 5cP.

A second aspect of the present invention provides a process for printing an image on a substrate comprising applying thereto by means of an ink jet printer an ink according to the first aspect of the present invention. The preferences for the ink used in this process are as hereinbefore defined in relation to the first aspect of the present invention.

The ink jet printer preferably applies the ink to the substrate in the form of droplets which are ejected through a small orifice onto the substrate. Preferred ink jet printers are piezoelectric ink jet printers and thermal ink jet printers. In thermal ink jet printers, programmed pulses of heat are applied to the ink in a reservoir by means of a resistor adjacent to the orifice, thereby causing the ink to be ejected in the form of small droplets directed towards the substrate during relative movement between the substrate and the orifice. In piezoelectric ink jet printers the oscillation of a small crystal causes ejection of the ink from the orifice.

The substrate is preferably paper, plastic, a textile, metal or glass, more preferably paper, an overhead projector slide or a textile material, especially paper.

Preferred papers are plain or treated papers which may have an acid, alkaline or neutral character. Examples of commercially available papers include, HP Premium Coated Paper, HP Photopaper (all available from Hewlett Packard Inc.), Stylus Pro 720 dpi Coated Paper, Epson Photo Quality Glossy Film, Epson Photo Quality Glossy Paper (available from Seiko Epson Corp.), Canon HR 101 High Resolution Paper, Canon GP 201 Glossy Paper, Canon HG 101 High Gloss Film (all available from Canon Inc.), Wiggins Conqueror paper (available from Wiggins Teape Ltd), Xerox Acid Paper and Xerox Alkaline paper, Xerox Acid Paper (available from Xerox).

A third aspect of the present invention provides a substrate, preferably a paper, an overhead projector slide or a textile material, printed with an ink according to the first aspect of the present invention or by means of the process according to the second aspect of the present invention.

According to a fourth aspect of the present invention there is provided an ink jet printer cartridge comprising a chamber and ink, wherein the ink is present in the chamber and the is as defined in the first aspect of the present invention.

According to an fifth aspect of the present invention there is provided an ink jet printer containing an ink jet printer cartridge, wherein the ink jet printer cartridge is as defined in the fourth aspect of the present invention.

The invention is further illustrated by the following Examples in which all parts and percentages are by weight unless specified otherwise.

### EXAMPLE 1

Compound (1) Wherein M is Nickel

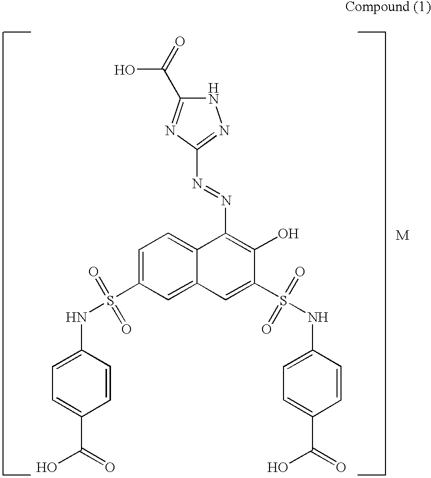

### Stage (a): Preparation of 2-acetoxynaphthalene-3,6-disulphonic acid

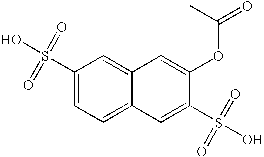

Acetic anhydride (350 ml, 3.8 mol) was added dropwise to a suspension of 2-hydroxynaphthalene-3,6-disulphonic acid di sodium salt (87 g, 0.25 mol) in N,N-dimethylacetamide (350 ml). The reaction mixture was stirred at 125° C. for 24 hours, cooled to room temperature and added to acetone (2500 ml). The product was filtered off, washed with acetone (3×100 ml) and dried to give 95.2 g of a cream coloured solid.

### Stage (b): Preparation of 3,6-bis-(4-carboxy-phenylsulfamoyl)-2-hydroxy-naphthalene

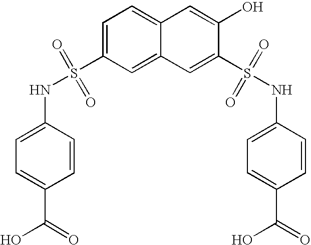

POCl₃ (50 ml, 0.538 mol) was added dropwise to a suspension of the product from stage (a) (50 g, 0.128 mol) in acetonitrile (250 ml) at reflux. The reaction mixture was stirred for 3 hours at 70° C., cooled, added to ice/water (4000 ml) and the naphthalene disulfonyl chloride extracted with dichloromethane (4×300 ml). The combined extracts were dried with MgSO₄, evaporated under reduced pressure and the residue dissolved in N,N-dimethylacetamide (400 ml). 4-Aminobenzoic acid (34.3 g, 0.25 mol) was added to the above solution, the reaction mixture was stirred overnight at room temperature and then added to water (3000 ml). The pH was then lowered to 0.5 with concentrated H₂SO₄ and the precipitated product extracted from ethyl acetate (4×300 ml). The combined extracts were washed with 1N HCl (600 ml), dried with MgSO₄ and evaporated under reduced pressure. The residue was dissolved in water (1000 ml) at pH 12 (2N NaOH) and then stirred for 1 hour at 50-60° C. The solution was allowed to cool, the pH lowered to pH 4 with concentrated HCI and the product filtered off and dried to give 41.5 g (53% yield) of a tan coloured solid.

Stage (c):

3-amino-1,2,4-triazole-5-carboxylic acid hydrate (1.28 g, 0.01 mol) was suspended in water (50 ml) and dissolved by the addition of 2M NaOH to pH 8. Sodium nitrite (0.76 g, 0.011 mol) was added and the solution stirred until the sodium nitrite had dissolved.

The mixture was then added dropwise to a cooled mix of ice-water (30 g) and concentrated HCl (3.0 ml) at 0-5° C., the mixture was stirred for 30 minutes at 0-5° C. and then excess nitrous acid was removed by adding sulphamic acid. The diazo suspension was added slowly to a solution of the product from stage (b) (5.42 g, 0.01 mol) in water (100 ml) at pH 7-8 (2N NaOH) cooled below 5° C. The reaction mixture was then stirred at 0-5° C. for one further hour, the product was precipitated by acidification to pH 4 with 2N HCl and collected by filtration. The product was then washed with water and dried in a vacuum desiccator to give 6.4 g of an orange solid.

Stage (d): Preparation of Compound (1)

A solution of nickel acetate tetrahydrate (1.38 g, 0.0055 mol) in water (10 ml) was added dropwise to the product from stage (c) (5.0 g, 0.0073 mol) dissolved in water (100 ml) at pH 7 (2N NaOH). The reaction mixture was stirred for 2 hours at ambient temperature, dialysed using SpectraPor membrane tubing (molecular weight cut off 3500) to low conductivity (<100 μs). The product was obtained by evaporation under reduced pressure to afford a dark crystalline solid (6 g). Analysis by mass spectrometry found m/z 1419. Requires M⁺=1420.

### EXAMPLE 2

### Inks

The inks described in Tables I and II may be prepared wherein the Compound described in the first column is the Compound made in Example 1. Numbers quoted in the second column onwards refer to the number of parts of the relevant ingredient and all parts are by weight. The inks may be applied to paper by thermal or piezo ink jet printing.

The following abbreviations are used in Table I and II:
PG=propylene glycol
DEG=diethylene glycol
NMP=N-methyl pyrollidone
DMK=dimethylketone
IPA=isopropanol
MEOH=methanol
2P=2-pyrollidone
MIBK=methylisobutyl ketone
P12=propane-1,2-diol
BDL=butane-2,3-diol
CET=cetyl ammonium bromide
PHO=Na₂HPO₄ and
TBT=tertiary butanol

TDG=thiodiglycol

TABLE I

| | Dye | | | | | | | Na | | | | |
|---|---|---|---|---|---|---|---|---|---|---|---|---|
| Compound | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 1 | 3.0 | 90 | | 5 | 5 | | 0.2 | | | | | |
| 1 | 10.0 | 85 | 3 | | 3 | 3 | | | | 5 | 1 | |
| 1 | 2.1 | 91 | | 8 | | | | | | | | 1 |
| 1 | 3.1 | 86 | 5 | | | | | 0.2 | 4 | | | 5 |
| 1 | 1.1 | 81 | | | 9 | | 0.5 | 0.5 | | | 9 | |
| 1 | 2.5 | 60 | 4 | 15 | 3 | 3 | | | 6 | 10 | 5 | 4 |
| 1 | 5 | 65 | | 20 | | | | | 10 | | | |
| 1 | 2.4 | 75 | 5 | 4 | | 5 | | | | 6 | | 5 |
| 1 | 4.1 | 80 | 3 | 5 | 2 | 10 | | 0.3 | | | | |
| 1 | 3.2 | 65 | | 5 | 4 | 6 | | | 5 | 4 | 6 | 5 |
| 1 | 5.1 | 96 | | | | | | | | 4 | | |
| 1 | 10.8 | 90 | 5 | | | | | | 5 | | | |
| 1 | 10.0 | 80 | 2 | 6 | 2 | 5 | | | 1 | | 4 | |
| 1 | 1.8 | 80 | | 5 | | | | | | | 15 | |
| 1 | 2.6 | 84 | | | 11 | | | | | | 5 | |
| 1 | 3.3 | 80 | 2 | | | 10 | | | | 2 | | 6 |
| 1 | 12.0 | 90 | | | | 7 | 0.3 | | 3 | | | |
| 1 | 5.4 | 69 | 2 | 20 | 2 | 1 | | | | | 3 | 3 |
| 1 | 6.0 | 91 | | | 4 | | | | | | 5 | |

TABLE II

| Compound | Dye Content | Water | PG | DEG | NMP | CET | TBT | TDG | BDL | PHO | 2P | PI2 |
|---|---|---|---|---|---|---|---|---|---|---|---|---|
| 1 | 3.0 | 80 | 15 | | | 0.2 | | | | | 5 | |
| 1 | 9.0 | 90 | | 5 | | | | | | 1.2 | | 5 |
| 1 | 1.5 | 85 | 5 | 5 | | 0.15 | 5.0 | 0.2 | | | | |
| 1 | 2.5 | 90 | | 6 | 4 | | | | | 0.12 | | |
| 1 | 3.1 | 82 | 4 | 8 | | 0.3 | | | | | | 6 |
| 1 | 0.9 | 85 | | 10 | | | | | 5 | 0.2 | | |
| 1 | 8.0 | 90 | | 5 | 5 | | | 0.3 | | | | |
| 1 | 4.0 | 70 | | 10 | 4 | | | | 1 | | 4 | 11 |
| 1 | 2.2 | 75 | 4 | 10 | 3 | | | | 2 | | 6 | |
| 1 | 10.0 | 91 | | | 6 | | | | | | 3 | |
| 1 | 9.0 | 76 | | 9 | 7 | | 3.0 | | | 0.95 | 5 | |
| 1 | 5.0 | 78 | 5 | 11 | | | | | | | 6 | |
| 1 | 5.4 | 86 | | | 7 | | | | | | 7 | |
| 1 | 2.1 | 70 | 5 | 5 | 5 | 0.1 | 0.2 | 0.1 | 5 | 0.1 | 5 | |
| 1 | 2.0 | 90 | | 10 | | | | | | | | |
| 1 | 2 | 88 | | | | | | 10 | | | | |
| 1 | 5 | 78 | | | 5 | | | 12 | | | 5 | |
| 1 | 8 | 70 | 2 | | 8 | | | 15 | | | 5 | |
| 1 | 10 | 80 | | | | | | 8 | | | 12 | |
| 1 | 10 | 80 | | 10 | | | | | | | | |

1. An ink comprising:
(a) a metal chelate compound of Formula (1) or salt thereof, wherein M is nickel; 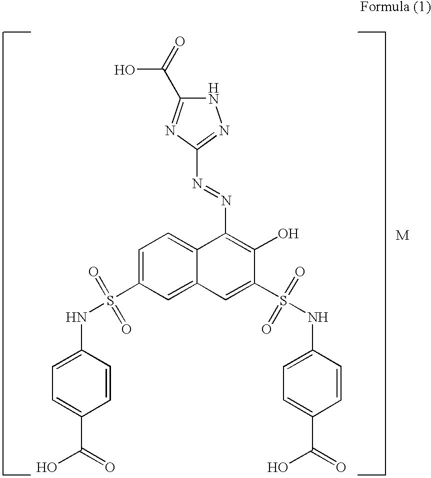
and (b) a liquid medium.

2. An ink according to claim 1 wherein the liquid medium comprises a mixture of water and an organic solvent.

3. An ink according to claim 1 or 2 comprising
(i) 1 to 10 parts of the compound of Formula (1) or salt thereof;
(ii) 2 to 60 parts of water-soluble organic solvent; and
(iii) 30 to 97 parts water;
wherein all parts are by weight and the sum of parts (i)+(ii)+(iii)=100.

4. A process for printing an image on a substrate comprising applying thereto by means of an ink jet printer an ink according to claim 1 or 2.

5. A substrate printed with an ink according to claim 1 or 2.

6. An ink jet printer cartridge comprising a chamber and ink, wherein the ink is present in the chamber and the ink is as defined in claim 1 or 2.

7. An ink jet printer containing an ink jet printer cartridge, wherein the ink jet printer cartridge is as defined in claim 6.

8. (canceled)

9. A substrate printed with an ink according to the process of claim 4.
